(19) United States
(12) Patent Application Publication
(10) Pub. No.: US 2020/0132272 A1
(43) Pub. Date: Apr. 30, 2020

(54) CEILING LIGHT FIXTURE

(71) Applicant: Michael Turner, Burlington (CA)

(72) Inventor: Michael Turner, Burlington (CA)

(21) Appl. No.: 16/170,657

(22) Filed: Oct. 25, 2018

(51) Int. Cl. F21V 3/04; F21V 3/02; F21S 8/02; G09F 13/04; G09F 23/00

(52) U.S. Cl. CPC F21V 3/049; F21V 3/02; F21W 2121/00; G09F 13/0413; G09F 23/00; F21S 8/026

(57) ABSTRACT

A light fixture housing contains an LED light source. A continuous light diffuser having a main body portion is defined between a first surface and a second surface of the continuous light diffuser, and is positioned within the housing to fully cover a light emitting opening formed in the housing. A discontinuous light diffuser having a main body portion is defined between a first surface and a second surface of the discontinuous light diffuser. A plurality of openings pass from the first surface of the discontinuous light diffuser through the main body portion to the second surface of the discontinuous light diffuser. The discontinuous light diffuser is positioned with its body portion in adjacent relation to either one of the first surface and the second surface of the continuous light diffuser so as to occlude a portion of the light emitting opening.

### FIELD OF THE INVENTION

The present invention relates to recessed light fixtures for installation in ceilings in commercial buildings, and more particularly to such recessed light fixtures having central diffusers.

### BACKGROUND AND SUMMARY OF THE INVENTION

The use of fluorescent lighting systems has been known in commercial buildings for many years. In office and commercial environments and the like, fluorescent lighting systems typically are ceiling mounted and comprise a recessed light fixture having a metal housing having a bottom opening. One or two elongate fluorescent light tubes are typically mounted in the housing to shine generally downwardly. One or more large reflecting surfaces may be used to reflect light from the fluorescent light tubes. The large reflecting surfaces may be part of the housing or may be separate elements mounted in the housing. A light diffuser is typically disposed at the bottom opening to diffuse light emanating from the fluorescent light tubes.

The most common type of light diffuser for a ceiling mounted light fixture that is installed in the ceiling of a building typically comprises a solid sheet of transparent or translucent plastic sheet material having a regular pre-determined pattern formed in one or both of the opposed top and bottom surfaces. While such light diffusers perform well, they have at least two drawbacks. First, they do not allow for any air-flow to pass therethrough. In some instances, this lack of air-flow can lead to undesirable heat build-up. Also, no direct light passes unimpeded through the material of the diffuser. In some specific applications, it is desirable to provide unimpeded direct light onto surfaces being illuminated.

U.S. Pat. No. 5,988,829 issued Nov. 23, 1999 to Holder, and entitled Direct/Indirect Lighting Fixtures, discloses a lighting fixture having a housing, two elongate central lamp sockets, reflectors outboard of the lamp sockets, and an elongate central diffuser under the elongate central lamp sockets. The diffuser may comprise a solid non-perforated sheet of transparent plastic sheet material, or alternatively, may comprise a perforated sheet of transparent plastic sheet material. The perforations in the sheet of transparent plastic sheet material, as disclosed in the Holder patent, are small and presented in a regular simple pattern.

Recently, light emitting diode (LED) light sources have been used to replace fluorescent light tubes in many recessed light fixtures for the sake of energy conservation. This replacement is being carried out both by the sale of brand new recessed ceiling light fixtures having integral LED light strips as their light source and by the retrofitting of existing recessed ceiling light fixtures with LED light sources arranged in tubes replacing the original fluorescent light tubes.

In both situations, a significant problem with LED light tubes and strips is that the light produced thereby is generally harsher and of higher intensity than that produced by non-LED light sources, even where the nominal power rating is the same as between the original and the replacement light sources.

Moreover, LED light sources are inherently prone to more glare and eye strain than fluorescent light sources, most likely attributable to the higher wavelengths and pulsing nature of the light they emit.

Additionally, LED light strips typically have a series of discrete LED sources arranged along a linear axis, which may or may not be contained in a frosted glass or plastic tube. Such linearly arranged sources produce uneven light distribution with hot spots along their lengths. The simple regular pattern of small perforations in diffusers such as those taught in the Holder patent cannot compensate for such glare and hot spots and uneven light distribution along the length of LED light tubes.

It is another object of the present invention to provide a recessed light fixture for installation in a ceiling of an office or commercial building, wherein the intensity of the light emanating from the light fixture can be controlled.

It is another object of the present invention to provide a recessed light fixture for installation in a ceiling of an office or commercial building, wherein the intensity of the light emanating from the light fixture can be controlled in retrofit situations involving the replacement of fluorescent tube fixtures.

It is another object of the present invention to provide a recessed light fixture for installation in a ceiling of a commercial building, wherein the recessed light fixture substantially precludes glare.

It is yet another object of the present invention to provide a recessed light fixture for installation in a ceiling of an office or commercial building, wherein the recessed light fixture substantially precludes hot spots in the light emanating therefrom.

It is an object of the present invention to provide a recessed light fixture for installation in a ceiling of an office or commercial building, wherein the recessed light fixture produces even light distribution.

It is an object of the present invention to provide a recessed light fixture for installation in a ceiling of an office or commercial building, wherein the recessed light fixture substantially ameliorates and/or overcomes the negative properties of pulsing light emanating from LED lights.

There is thus disclosed according to one aspect of the present invention in combination, a light fixture housing defining a light emitting opening and a first housing axis and a second housing axis transverse one to the other. A continuous light diffuser has a main body portion defined between a first surface and a second surface of the continuous light diffuser. The continuous light diffuser is positioned within the housing to fully cover the light emitting opening formed in the housing. A discontinuous light diffuser has a main body portion defined between a first surface and a second surface of the discontinuous light diffuser. The main body portion has a major axis and a minor axis transverse one to the other. A plurality of openings pass from the first surface of the discontinuous light diffuser through the main body portion to the second surface of the discontinuous light diffuser. The discontinuous light diffuser is positioned with its body portion in adjacent relation to either one of the first surface and the second surface of the continuous light diffuser so as to occlude a portion of the light emitting opening.

The above and other objects, advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described hereinbelow.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a perspective view from below of a first type of conventional prior art fluorescent ceiling light fixture mounted within a conventional T-bar ceiling grid and having a first conventional flexible translucent light diffuser covering the light emitting opening of the fixture;

FIG. 2A is a perspective view similar to FIG. 1, but with a first exemplary embodiment of a discontinuous light diffuser according to the present invention in place and supported by the first embodiment flexible translucent light diffuser similar to FIG. 1 to thereby occlude a portion of the light emitting opening of the ceiling light fixture;

FIG. 2B is an exploded perspective view similar to FIG. 2A, with the discontinuous light diffuser according to the present invention shown in dashed outline vertically separated from the flexible translucent light diffuser before being placed thereon (in solid outline) and also showing a pair of LED light tubes retrofitted within the fixture;

FIG. 3A is a perspective view similar to FIG. 2A, but showing a second exemplary embodiment of a discontinuous light diffuser according to the present invention;

FIG. 3B is an exploded perspective view similar to FIG. 3A, with the discontinuous light diffuser according to the present invention shown in dashed outline vertically separated from the flexible translucent light diffuser before being placed thereon (in solid outline) and also showing a pair of LED light tubes retrofitted within the fixture;

FIG. 4 is a perspective view from below of a second type of conventional prior art LED ceiling light fixture having a second embodiment of a flexible continuous light diffuser covering the light emitting opening of the fixture;

FIG. 5A is a perspective view similar to FIG. 4, but with a third exemplary embodiment of a discontinuous light diffuser according to the present invention in place below the second embodiment of flexible continuous light diffuser to thereby occlude a portion of the light emitting opening of the LED ceiling light fixture;

FIG. 5B is a bottom plan view of the LED ceiling light fixture of FIG. 5A;

FIG. 5C is a bottom partially exploded perspective view of the LED ceiling light fixture of FIG. 5A, showing the third exemplary embodiment of light diffuser according the to the present invention being installed in place under the flexible continuous light diffuser;

FIG. 5D is a sectional end elevation view taken along section lines 5D-5D of FIG. 5C and showing the continuous light diffuser, and also the third exemplary embodiment of the discontinuous light diffuser according to the present invention in dashed outline being installed in place under the flexible continuous light diffuser;

FIG. 5E is a sectional end elevation view similar to FIG. 5D, but with the third exemplary embodiment of the discontinuous light diffuser according the to the present invention having been fully installed in place under the flexible continuous light diffuser;

FIG. 5F is an enlarged sectional end elevation view of the encircled area 5F of FIG. 5E;

FIG. 6A is a perspective view from below of the same type of LED ceiling light fixture as shown in FIG. 5A, having a fourth exemplary embodiment of light diffuser according to the present invention in place below the flexible continuous light diffuser to thereby occlude a portion of the light emitting opening of the LED ceiling light fixture, and also having a supplemental light diffuser according the to the present invention;

FIG. 6B is a bottom plan view of the LED ceiling light fixture of FIG. 6A, including the fourth embodiment flexible continuous light diffuser and the supplemental light diffuser according the to the present invention;

FIG. 6C is a bottom partially exploded perspective view of the LED ceiling light fixture of FIG. 6A, showing the fourth exemplary embodiment of discontinuous light diffuser and the supplemental light diffuser according the to the present invention each being installed in place under the flexible continuous light diffuser;

FIG. 6D is a sectional end elevation view taken along section lines 6D-6D of FIG. 6B and showing the continuous light diffuser, and the fourth exemplary embodiment of the discontinuous light diffuser and the supplemental light diffuser according to the present invention in dashed outline being installed in place under the flexible continuous light diffuser;

FIG. 6E is a sectional end elevation view similar to FIG. 6D, but with the fourth exemplary embodiment of light diffuser according the to the present and the supplemental light diffuser invention having been fully installed in place; and,

FIG. 6F is an enlarged sectional end elevation view of the encircled area 6F of FIG. 6E.

### DETAILED DESCRIPTION OF THE EXEMPLARY EMBODIMENTS

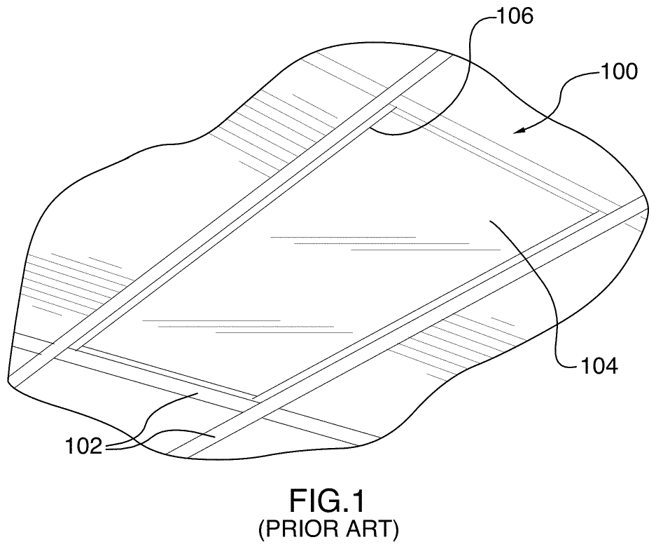

FIG. 1 shows a conventional prior art fluorescent ceiling light fixture 100 mounted within a conventional T-bar ceiling grid 102. The fluorescent ceiling light fixture 100 has a first conventional flexible translucent light diffuser 104 covering the light emitting opening 106 of the fluorescent ceiling light fixture 100.

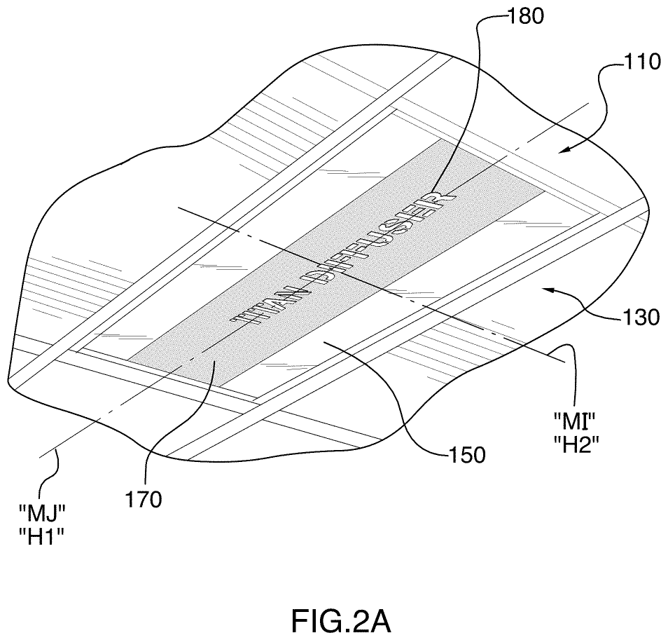

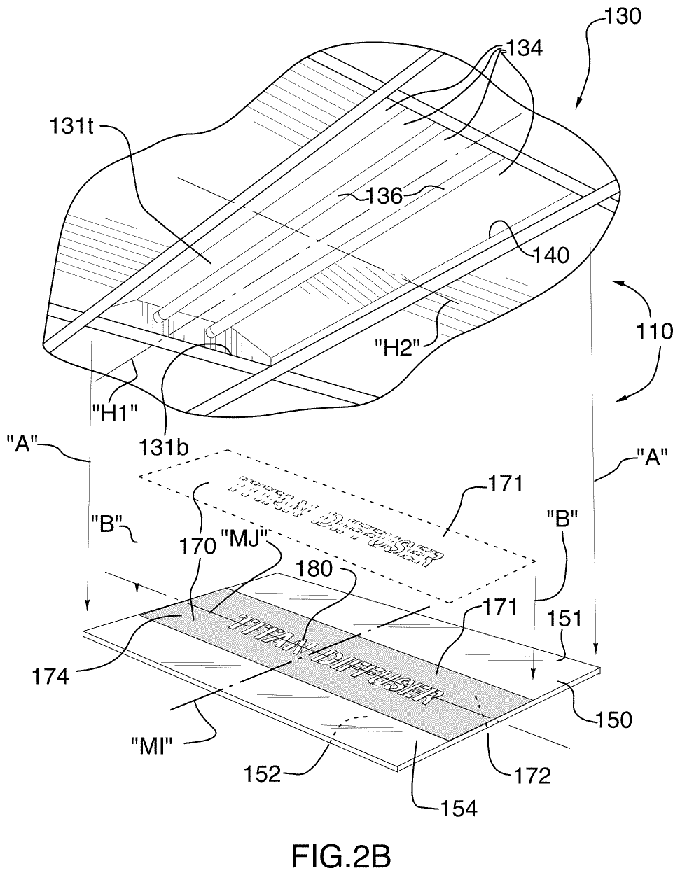

Reference will now be made to FIGS. 2A and 2B, which show a first exemplary embodiment according to the present invention. In brief, the first exemplary embodiment according to the present invention comprises, in a combination as indicated by general reference numeral 110, a ceiling light fixture housing as indicated by the general reference numeral 130, a continuous light diffuser 150 having no openings therein, and a discontinuous light diffuser 170 having openings 180 therein.

More specifically, as can be best seen in FIG. 2B, the ceiling light fixture housing 130 defines a main body 132 having a top 131t, a bottom 131b, a downwardly facing reflector 134, a first housing axis “H1” and a second housing axis “H2” transverse one to the other, and a pair of tube sockets (not specifically shown) disposed one adjacent each end of the main body 132 for mounting fluorescent light tubes 136 within the ceiling light fixture housing 130. As illustrated, but not necessarily, the ceiling light fixture housing 130 is longer along the first housing axis “H1” and shorter along the second axis “H2”.

A light emitting opening 140 is defined at the bottom 131b of the ceiling light fixture housing 130. Also, as can be best seen in FIG. 2B, the ceiling light fixture housing 130 has mounted therein a pair of LED light tubes 136 retrofitted within the light fixture housing 130. Light generated by the LED light tubes 136 emanates from the ceiling light fixture housing 130 through the light emitting opening 140.

The continuous light diffuser 150 has a main body portion 154 defined between a first surface 151 and a second surface 152 of the continuous light diffuser 150. As illustrated, the continuous light diffuser 150 is oriented such that the first surface 151 is a top surface and the second surface 152 is a bottom surface. As illustrated, the main body portion 154 of the continuous light diffuser 150 is generally planar and is shaped and dimensioned to fit within the ceiling light fixture housing 130 at the bottom 131t thereof, at the light emitting opening 140. As can be readily seen, the continuous light diffuser 150 is positioned within the ceiling light fixture housing 130 to fully cover the light emitting opening 140 formed in the ceiling light fixture housing 130.

Also, the first surface 151 of the main body portion 154 of the continuous light diffuser 150 is generally planar and the second surface 152 of the main body portion 154 of the continuous light diffuser 150 is also generally planar. Further, the first surface 151 and the second surface 152 of the main body portion 154 of the continuous light diffuser 150 are substantially parallel one to the other. These above discussed properties are for the sake of simplicity and ease of manufacturing. The overall shape of the continuous light diffuser 150, as illustrated, is rectangular; however, any suitable shape could be employed so as to fully cover the light emitting opening 140.

FIGS. 2A and 2B illustrate a first exemplary embodiment of the discontinuous light diffuser 170, which has a main body portion 174 defined between a first surface 171 and a second surface 172 of the discontinuous light diffuser 170.

As illustrated, the main body portion 174 of the discontinuous light diffuser 170 is preferably formed from a resilient plastic sheet material and is generally planar and shaped and dimensioned to fit within the ceiling light fixture housing 130 at the bottom 131t thereof adjacent the light emitting opening 140. Also, the first surface 171 of the main body portion 174 of the discontinuous light diffuser 170 is generally planar and the second surface 172 of the main body portion 174 of the discontinuous light diffuser 170 is also generally planar. Further, the first surface 171 and the second surface 172 of the main body portion 174 of the discontinuous light diffuser 170 are substantially parallel one to the other. These above discussed properties are for the sake of simplicity and ease of manufacturing. The overall shape of the discontinuous light diffuser 170, as illustrated, is rectangular; however, any suitable shape could be employed.

The main body portion 174 also has a major axis “MJ” and a minor axis “MI” transverse one to the other. The first housing axis “H1” of the ceiling light fixture housing 130 and the major axis “MJ” of the discontinuous light diffuser 170 are preferably parallel one to the other. Similarly, the second housing axis “H2” of the ceiling light fixture housing 130 and the minor axis “MI” of the discontinuous light diffuser 170 are preferably parallel one to the other. Also, the discontinuous light diffuser 170 is also preferably longer along the major axis “MA” and shorter along the minor axis “MI”.

The plurality of openings 180 in the main body portion 174 of the discontinuous light diffuser 170 pass from the first surface 171 of the discontinuous light diffuser 170 through the main body portion 174 to the second surface 172 of the discontinuous light diffuser 170. It is the plurality of openings 180 in the main body portion 174 that make the light diffuser 170 discontinuous. It should be noted that for the sake of simplicity and clarity, only reference numeral 180 is used to indicate the plurality of openings 180. These openings 180 are light passing openings that allow light produced by the two fluorescent light tubes 136 to shine through the main body portion 174 of the discontinuous light diffuser 170 and emanate therefrom in order to illuminate a room below (not specifically illustrated). The main body portion 174 is preferably formed from a light blocking opaque plastic sheet material, or at least a translucent plastic sheet material. The openings 180 may be formed in the main body portion 174 by, for example, being stamped, die cut or laser cut in a full sheet of such plastic sheet material, but the invention is not limited to any particular method of forming same.

In FIG. 2A, the first exemplary embodiment of the discontinuous light diffuser 170 is shown in solid outline in place on the continuous light diffuser 150. In FIG. 2B, the first exemplary embodiment of the discontinuous light diffuser 170 is shown in dashed outline vertically separated from the continuous light diffuser 150, as indicated by arrows “A”, before being placed thereon, and is shown in solid outline once the discontinuous light diffuser 170 has been placed on the continuous light diffuser 150, as indicated by arrows “B”. As can be readily seen, the discontinuous light diffuser 170 is positioned with its second surface 172, which faces downwardly in the figures, in contacting relation with the first surface 151, which faces upwardly in the figures, of the continuous light diffuser 150. In this manner, the first exemplary embodiment of the discontinuous light diffuser 170 according to the present invention sits in an operative position atop, and supported by, the first embodiment of the continuous light diffuser 150.

In the first exemplary embodiment of the discontinuous light diffuser 170, the plurality of openings 180 in the discontinuous light diffuser 170 forms at least one of symbols and letters and numbers. The symbols and letters and numbers may form a commercial message. More specifically, and as can be readily seen in FIGS. 2A and 2B, the plurality of openings 180 form letters in the first exemplary embodiment of the discontinuous light diffuser 170. As chosen and situated, the plurality of openings 180 form letters that spell two words, namely “TITAN DIFFUSER”.

Alternatively, it is contemplated that the plurality of openings 180 in the discontinuous light diffuser 170 could form seasonal or other decorative shapes or figures, either alone, or in combination with words, numbers or other indicia.

It has been found that in many LED retrofit situations, the discontinuous light diffuser 170 is effective if positioned as shown in FIGS. 2A and 2B with its main body portion 174 in adjacent relation to either one of the first surface 151 and the second surface 152 of the continuous light diffuser 150 so as to occlude a portion of the light emitting opening 140. More specifically, as can be readily seen in FIGS. 2A and 2B, the discontinuous light diffuser 170 is positioned with its main body portion 174, specifically the downwardly facing second surface 172, in adjacent relation to the upwardly facing first surface 151 of the continuous light diffuser 150, so as to occlude a portion of the light emitting opening 140. In this manner, the intensity and glare of the light emanating from the two retrofitted LED light tubes 136, and the number and severity of the hot spots associated with these two LED light tubes 136, can be controlled and substantially even light distribution can be achieved. It should be noted that the portion of the light emitting opening 140 occluded by the discontinuous light diffuser 170 is partial, although it is quite possible and quite acceptable that the portion of the light emitting opening 140 occluded by the discontinuous light diffuser 170 be fully occluded.

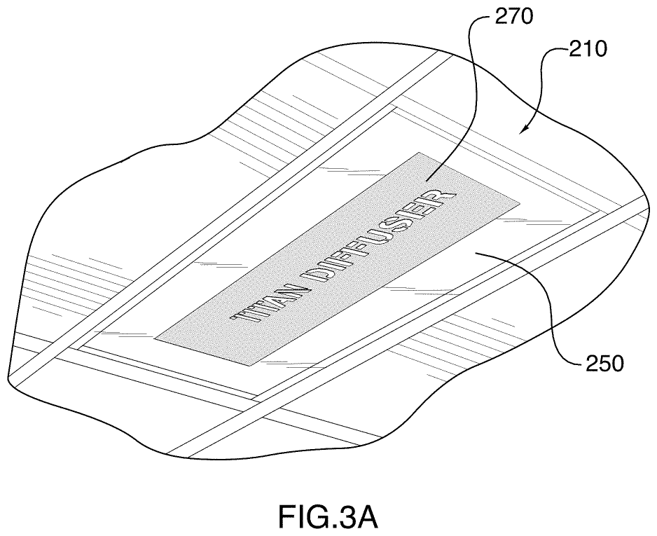

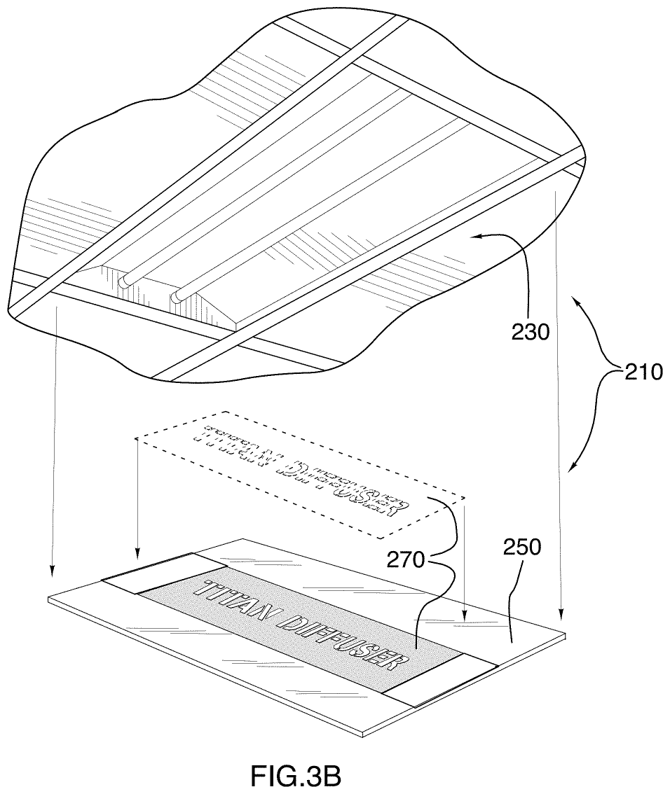

Reference will now be made to FIGS. 3A and 3B to discuss the second exemplary embodiment of the present invention. In brief, the second exemplary embodiment according to the present invention is similar to the first exemplary embodiment in that it comprises, in combination as indicated by general reference numeral 210, a ceiling light fixture housing as indicated by the general reference numeral 230, a continuous light diffuser 250, and a discontinuous light diffuser 270. The ceiling light fixture housing 230 and the continuous light diffuser 250 are the same as the ceiling light fixture housing 130 and the continuous light diffuser 150 in the first exemplary embodiment combination 110. The discontinuous light diffuser 270 is similar to the discontinuous light diffuser 170 in the first exemplary embodiment combination 110 except that the length of the discontinuous light diffuser 270 is less than the length of the discontinuous light diffuser 170. Accordingly, the discontinuous light diffuser 170 does not extend the full length of the continuous light diffuser 250 when in place on the upwardly facing first surface 251 of the continuous light diffuser 250.

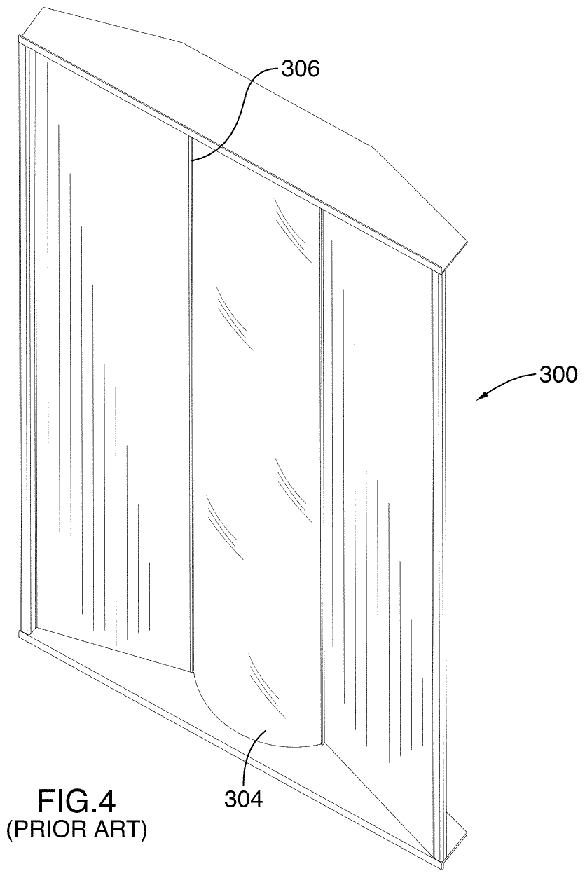

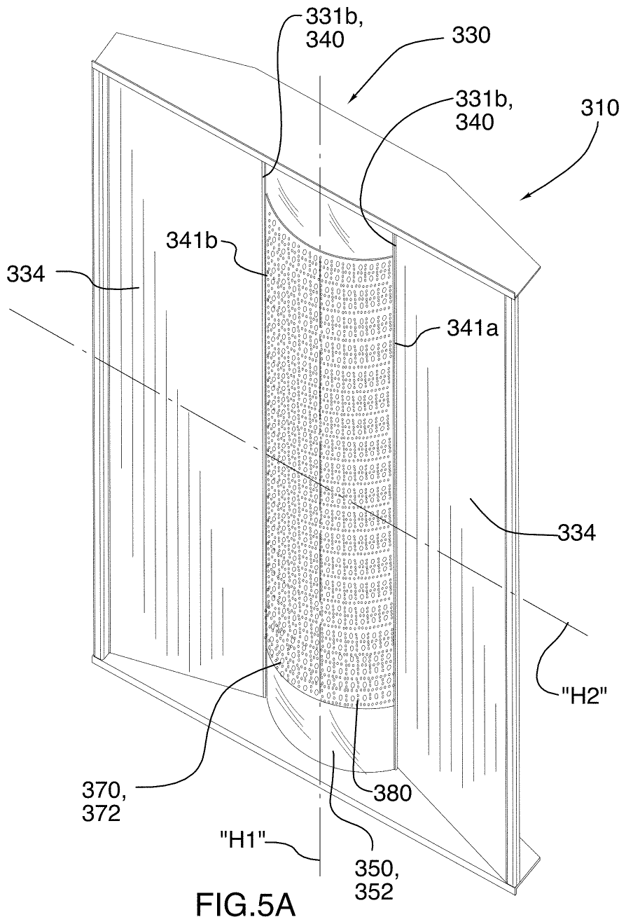

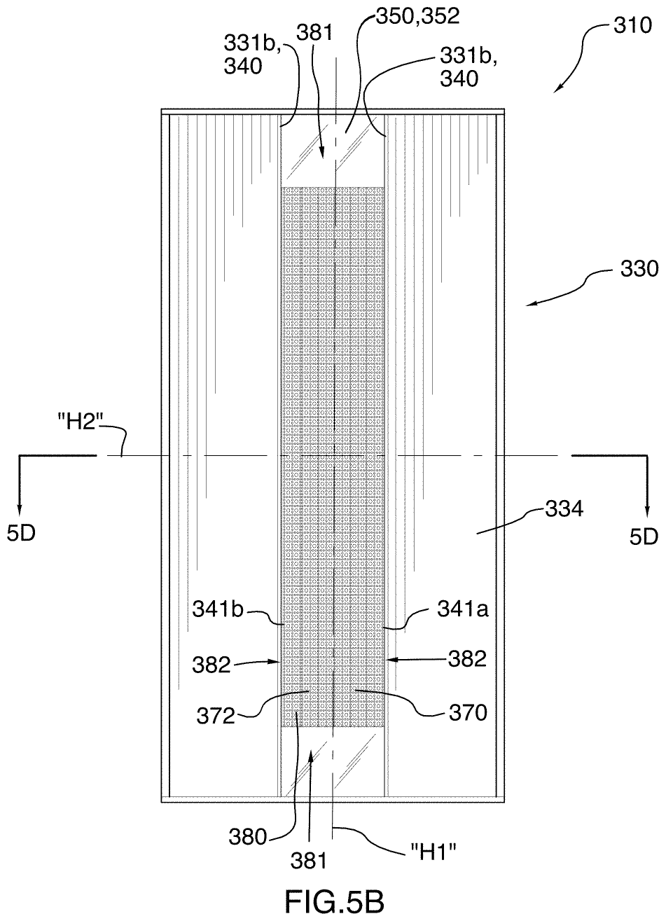

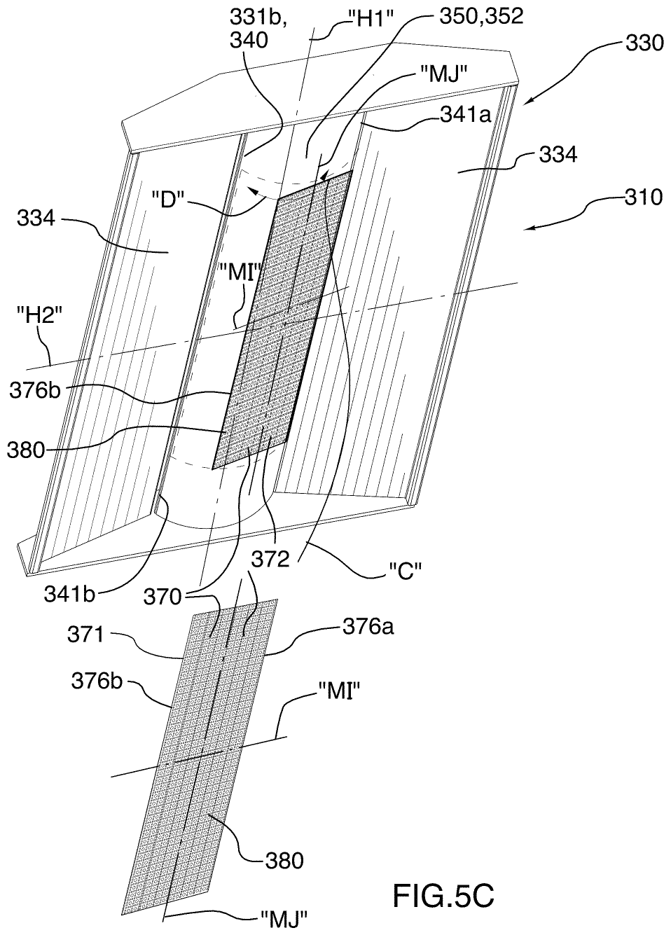

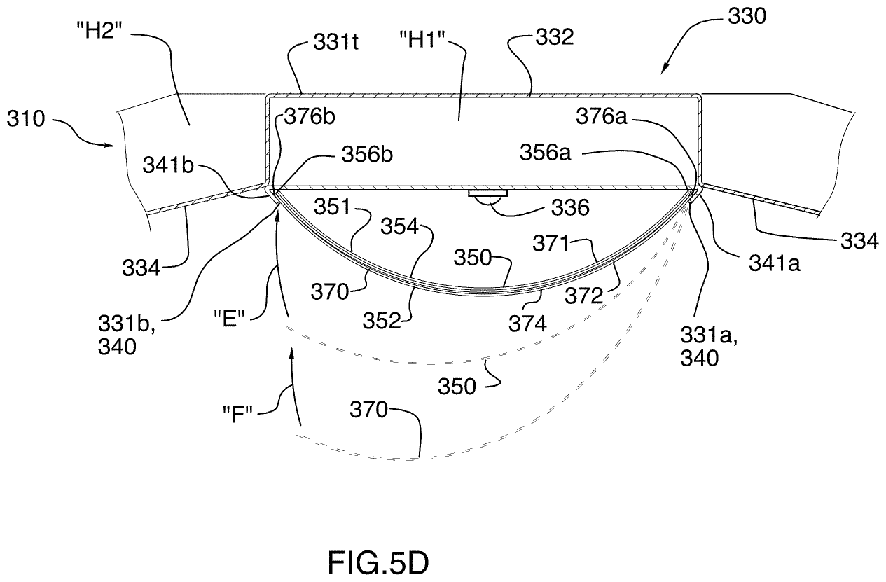

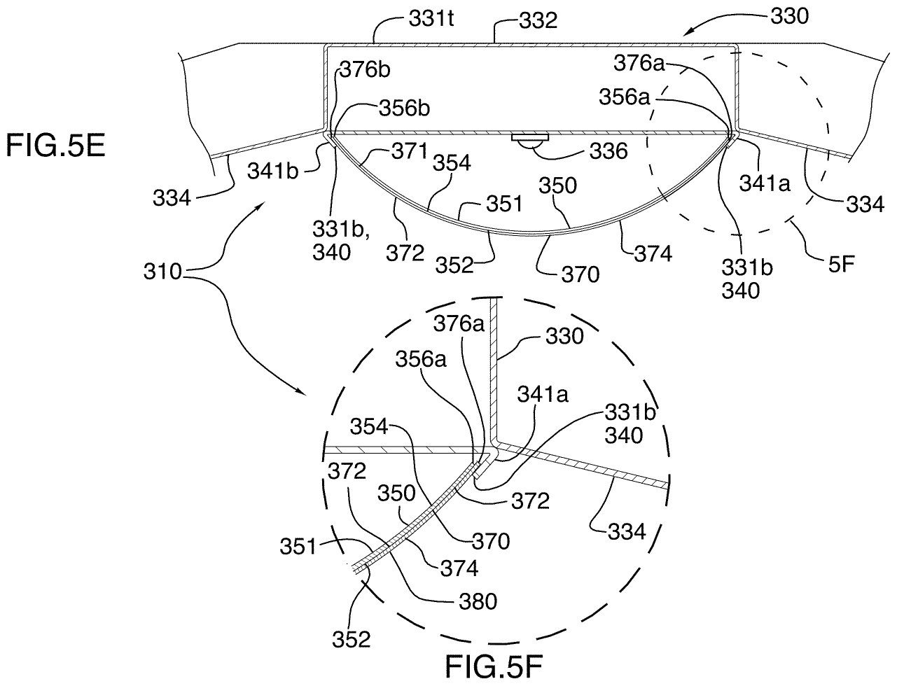

Reference will now be made to FIGS. 4 through 5F to discuss the third exemplary embodiment of the present invention.

FIG. 4 illustrates a conventional LED ceiling light fixture 300 mounted within a conventional T-bar ceiling grid 302. The LED ceiling light fixture 300 has a first conventional flexible translucent light diffuser 304 covering the light emitting opening 306 of the LED ceiling light fixture 300. As discussed in the background, the intensity and glare of the light emanating from the LED light strip (not specifically shown), the number and severity of the hot spots associated with the LED light strip, the uneven light distribution emanating from the LED light strips and the negative properties of pulsing LED light, can all be problematic.

Reference will now be made to FIGS. 5A through 5F, which show a third exemplary embodiment according to the present invention. In brief, the third exemplary embodiment according to the present invention comprises, in a combination as indicated by general reference numeral 310, a ceiling light fixture housing as indicated by the general reference numeral 330, a continuous light diffuser 350, and a discontinuous light diffuser 370.

More specifically, as can be best seen in FIG. 5D, the ceiling light fixture housing 330 defines a main body 332 having a top 331t, a bottom 331b, two downwardly facing reflectors 334, a first angled flange 341a and a second angled flange 341b. As can be best seen in FIGS. 5A through 5C, the ceiling light fixture housing 330 also defines a first housing axis “Hi” and a second housing axis “H2” transverse one to the other. As illustrated, but not essentially, the ceiling light fixture housing 330 is longer along the first housing axis “Hi” and shorter along the second axis “H2”.

A light emitting opening 340 is defined at the bottom 331b of the ceiling light fixture housing 330. Also, as can be best seen in FIGS. 5D and 5E, the ceiling light fixture housing 330 also has mounted therein a single LED light strip 336 mounted within the light fixture housing 330. Light generated by the LED light strip 336 emanates from the ceiling light fixture housing 330 through the light emitting opening 340.

The continuous light diffuser 350 is preferably formed from resilient plastic sheet material and has a main body portion 354 defined between a first surface 351 and a second surface 352 of the continuous light diffuser 350. As illustrated, the continuous light diffuser 350 is oriented such that the first surface 351 is a top surface and the second surface 352 is a bottom surface.

As illustrated in FIG. 5C, the main body portion 354 of the continuous light diffuser 350 is generally planar before installation. After the continuous light diffuser 350 is fully installed, as best seen in FIGS. 5A, 5B, 5D, 5E, and 5F, the continuous light diffuser 350 is of arcuately curved shaped, and is resiliently bent to the curved shape as shown in order to fit between the first angled flange 341a and the second angled flange 341b so as to be in bent compression. In this manner, the continuous light diffuser 350 is quickly and easily installed in removable and replaceable relation within the ceiling light fixture housing 330 at the bottom 331t thereof, specifically at the light emitting opening 340, without the need of hand tools or supplemental fastening means. The installation and removal of the continuous light diffuser 350 is further discussed subsequently.

As can be readily seen, once installed, the continuous light diffuser 350 is positioned within the ceiling light fixture housing 330 to fully extend across the width of the light emitting opening 340 (in the direction of the first housing axis “H1”) but extends only partially along the length of the light emitting opening 340 (in the direction of the second housing axis “H2”), to thereby only partially cover the light emitting opening 340 formed in the ceiling light fixture housing 330.

Also, before installation, the first surface 351 of the main body portion 354 of the continuous light diffuser 350 is generally planar and the second surface 352 of the main body portion 354 of the continuous light diffuser 350 is generally planar. Further, the first surface 351 and the second surface 352 of the main body portion 354 of the continuous light diffuser 350 are substantially parallel one to the other. These above discussed properties are for the sake of simplicity and ease of manufacturing. The overall shape of the continuous light diffuser 350, as illustrated, is rectangular; however, any suitable shape could be employed.

FIGS. 5A through 5F also show a third exemplary embodiment of the discontinuous light diffuser 370, which has a main body portion 374 defined between a first surface 371 and a second surface 372 of the discontinuous light diffuser 370. As illustrated, the discontinuous light diffuser 370 is oriented such that the first surface 371 is a top surface and the second surface 372 is a bottom surface.

The discontinuous light diffuser 370 has a main body portion 374 defined between a first surface 371 and a second surface 372 of the discontinuous light diffuser 370. As illustrated, the discontinuous light diffuser 370 is oriented such that the first surface 371 is a top surface and the second surface 372 is a bottom surface. As illustrated in FIG. 5C, the main body portion 374 of the discontinuous light diffuser 370 is generally planar before installation. After the discontinuous light diffuser 370 is fully installed, as best seen in FIGS. 5A, 5B, 5D, 5E, and 5F, the discontinuous light diffuser 370 is arcuately shaped, and is resiliently bent to the curved shape as shown in order to fit between the first angled flange 341a and the second angled flange 341b so as to be in bent compression. In this manner, the discontinuous light diffuser 370 is installed in removable and replaceable relation within the ceiling light fixture housing 330 at the bottom 331t thereof, specifically at the light emitting opening 340. The installation and removal of the discontinuous light diffuser 370 is discussed subsequently.

Also, before installation, the first surface 371 of the main body portion 374 of the discontinuous light diffuser 370 is generally planar and the second surface 372 of the main body portion 374 of the discontinuous light diffuser 370 is generally planar. Further, the first surface 371 and the second surface 372 of the main body portion 374 of the discontinuous light diffuser 370 are substantially parallel one to the other. These above discussed properties are for the sake of simplicity and ease of manufacturing. The overall shape of the discontinuous light diffuser 370, as illustrated, is rectangular; however, any suitable shape could be employed.

As can be seen in FIGS. 5A through 5C, the main body portion 374 also has a major axis “MJ” and a minor axis “MI” transverse one to the other. As illustrated, but not essentially, the main body portion 374, and therefore the discontinuous light diffuser 370, are longer along the major axis “MJ” and shorter along the minor axis “MI”.

The first housing axis “Hi” of the ceiling light fixture housing 330 and the major axis “MJ” of the discontinuous light diffuser 370 are parallel one to the other. Similarly, the second housing axis “H2” of the ceiling light fixture housing 330 and the minor axis “MI” of the discontinuous light diffuser 370 are parallel one to the other. Also, the discontinuous light diffuser 370 is longer along the major axis “MA” and shorter along the minor axis “MI”.

A plurality of openings 380 in the main body portion 374 of the discontinuous light diffuser 370 pass from the first surface 371 of the discontinuous light diffuser 370 through the main body portion 374 to the second surface 372 of the discontinuous light diffuser 370. It should be noted that for the sake of simplicity and clarity only reference numeral 380 is used to indicate the plurality of openings 380. These openings 380 are light passing openings that allow light produced by the LED light strip 336 to shine through the main body portion 374 of the discontinuous light diffuser 370 and emanate therefrom in order to illuminate a room below (not specifically illustrated). The main body portion 374 is preferably formed from a light blocking opaque plastic sheet material, or at least a translucent plastic sheet material. The openings 380 may be formed in the main body portion 374 by, for example, being stamped, die cut or laser cut in a full sheet of such plastic sheet material, but the invention is not limited to any particular method of forming same.

In FIG. 5A, the third exemplary embodiment of the discontinuous light diffuser 370 is shown in solid outline in place on the continuous light diffuser 350. In FIG. 5B, the third exemplary embodiment of the discontinuous light diffuser 370 is shown in dashed outline vertically separated from the continuous light diffuser 350, as indicated by arrows “A”, before being placed thereon, and is shown in solid outline once the discontinuous light diffuser 370 has been placed on the continuous light diffuser 350, as indicated by arrows “B”. As can be readily seen, the discontinuous light diffuser 370 is positioned with its first surface 371, which faces upwardly in the figures, in contacting relation with the second surface 352, which faces downwardly in the figures, of the continuous light diffuser 350. In this manner, the third exemplary embodiment of the discontinuous light diffuser 370 according to the present invention sits in an operative position under the continuous light diffuser 350.

In the third exemplary embodiment of the discontinuous light diffuser 370, the plurality of openings 380 in the discontinuous light diffuser 370 forms a pattern, and more specifically forms a regular pattern, with the plurality of openings 380 being aligned in columns 381 generally parallel to the major axis “MJ” of the discontinuous light diffuser 370 and with the plurality of openings 380 being aligned in rows 382 generally parallel to the minor axis “MI” of the discontinuous light diffuser 370. Only one column 381 and one row 382 are indicated in FIG. 5B for the sake of simplicity and clarity. Also, the plurality of openings 380 in the discontinuous light diffuser forms an array, and more specifically a regular array of circular openings 380. The regular array of circular openings 380 preferably comprises alternating columns 381 and rows 382 of circular openings 380 having a first size and circular openings 380 having a second size.

As can be best seen in FIGS. 5C and 5D, the installation of the continuous light diffuser 350 and the discontinuous light diffuser 370 is relatively straightforward. First, with the continuous light diffuser 350 in the position shown in dashed outline in FIG. 5D, the first side edge 356a of the continuous light diffuser 350 is engaged on the first angled flange 341a of the ceiling light fixture housing 330. Next, the continuous light diffuser 350 is bent and moved upwardly, as indicated by arrow “E”, to allow the second side edge 356b to engage on the second angled flange 341b. As can be seen in FIG. 5C, once the continuous light diffuser 350 is positioned as above, the discontinuous light diffuser 370 is then brought upwardly towards the ceiling light fixture housing 330 and the continuous light diffuser 350, as indicated by arrow “C”. The first side edge 356 is inserted between the continuous light diffuser 350 and the first angled flange 341a. When in place, the first side edge 376a of the discontinuous light diffuser 370 is engaged on the first angled flange 341a of the ceiling light fixture housing 330, under the continuous light diffuser 350 (see FIG. 5F which shows an enlarged view of the area of the first side edge 376a in place when the discontinuous light diffuser 370 is fully installed).

Similarly to the installation of the continuous light diffuser 350, with the discontinuous light diffuser 370 in the position shown in FIG. 5C and show in dashed outline in FIG. 5D, the discontinuous light diffuser 370 is bent and moved upwardly, as indicated by arrow “D” in FIG. 5C and by arrow “F” in FIG. 5F, to allow the second side edge 376b to engage on the second angled flange 341b, of the ceiling light fixture housing 330, under the continuous light diffuser 350.

As can be readily seen in FIGS. 5A, 5D and 5E, when installed in place, the main body portion 354 of the continuous light diffuser 350 and the main body portion 374 of the discontinuous light diffuser 370 is curved, and more specifically arcuately curved to the same general shape one as the other.

It has been found that the discontinuous light diffuser 370 is effective if positioned as shown in FIGS. 5A and 5B, with its main body portion 374 in adjacent relation to either one of the first surface 351 and the second surface 352 of the continuous light diffuser 350 so as to occlude a portion of the light emitting opening 340. More specifically, as can be readily seen in FIGS. 5A and 5B, the discontinuous light diffuser 370 is positioned with its main body portion 374, specifically the downwardly facing second surface 372, in adjacent relation to the upwardly facing first surface 351 of the continuous light diffuser 350, so as to occlude a portion of the light emitting opening 340. In this manner, the intensity and glare of the light emanating from the LED light strip 336, and the number and severity of the hot spots associated with the LED light strip 336, can be ameliorated and/or controlled. Also, even light distribution can be achieved. It should be noted that the portion of the light emitting opening 340 occluded by the discontinuous light diffuser 370 is partial, although it is quite possible and quite acceptable that the portion of the light emitting opening 340 occluded by the discontinuous light diffuser 370 be fully occluded.

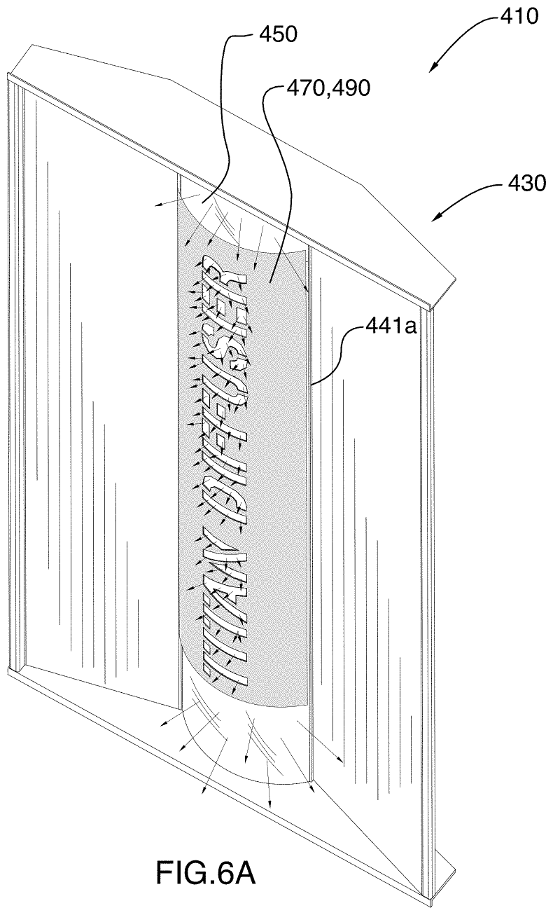

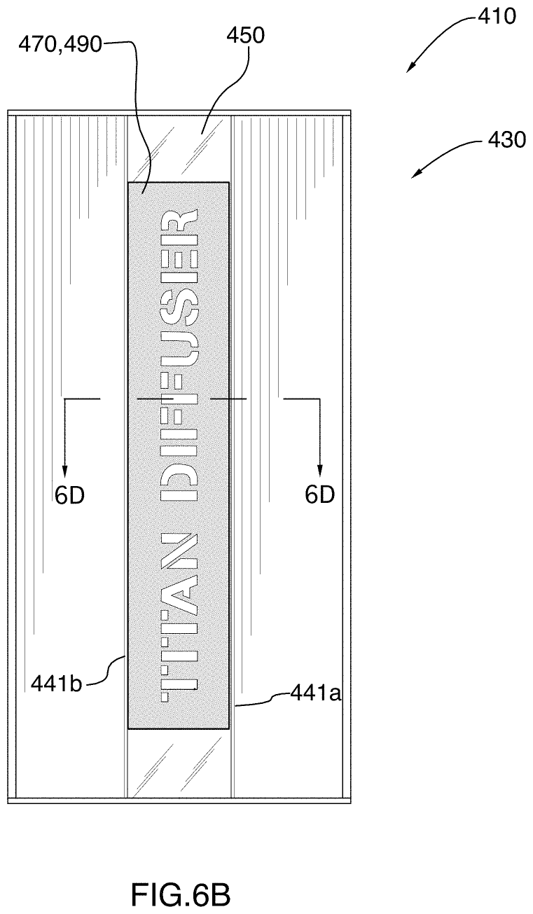

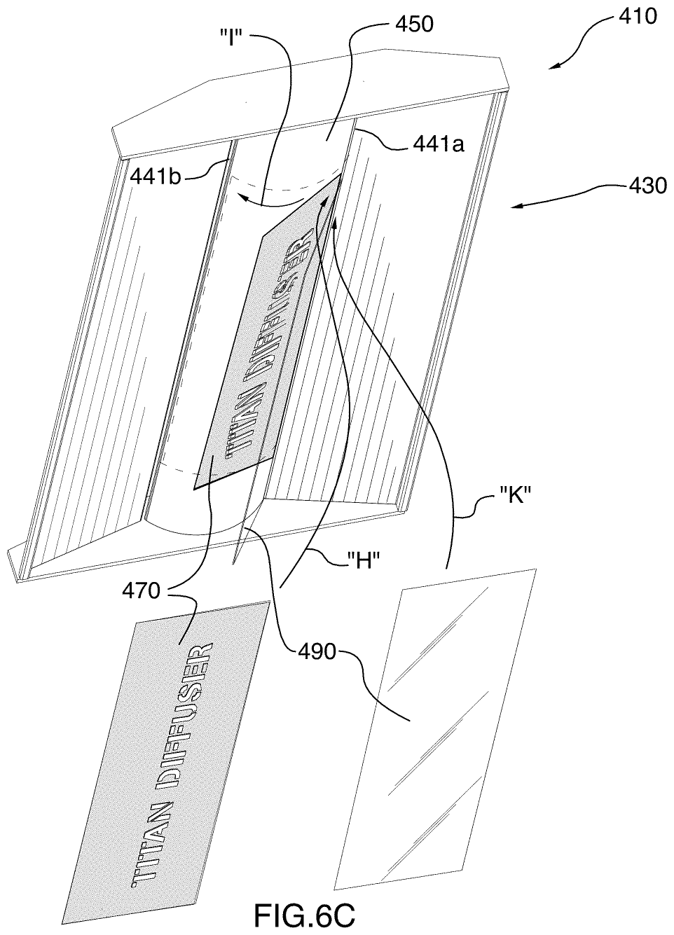

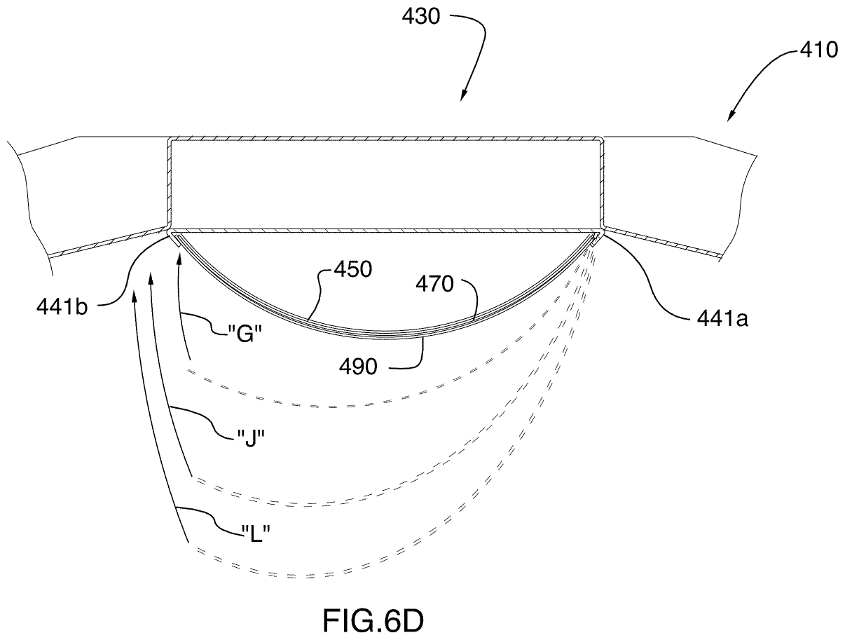

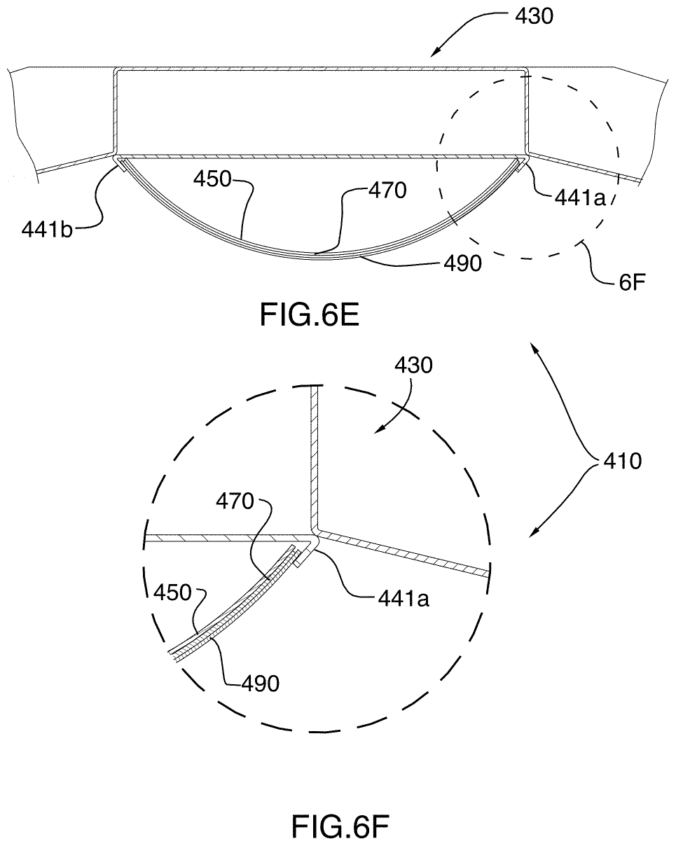

Reference will now be made to FIGS. 6A through 6F to discuss the fourth exemplary embodiment of the present invention. In brief, the fourth exemplary embodiment according to the present invention is similar to the third exemplary embodiment in that it comprises, in combination as indicated by general reference numeral 410, a ceiling light fixture housing as indicated by the general reference numeral 430, a continuous light diffuser 450, and a discontinuous light diffuser 470. The ceiling light fixture housing 430, the continuous light diffuser 450, and the discontinuous light diffuser 470 are the same as the ceiling light fixture housing 430, the continuous light diffuser 450 and the discontinuous light diffuser 470, respectively, in the third exemplary embodiment combination 410. Additionally, the fourth exemplary embodiment of the combination 410 further comprises supplemental means 490 for attaching the discontinuous light diffuser 470 in contacting relation with the continuous light diffuser 450. The supplemental means 490 for attaching the discontinuous light diffuser 470 in contacting relation with the continuous light diffuser 450 comprises a supplemental light diffuser 490. As illustrated, but not essential, the supplemental light diffuser 490 is preferably constructed from optically clear and flexible plastic sheet material. The supplemental light diffuser 490 is retained between the discontinuous light diffuser 470 and the first angled flange 441a and the second angled flange 441b, as can be best seen in FIGS. 6D through 6F.

As can be best seen in FIGS. 6C and 6D, the installation of the continuous light diffuser 450 and the discontinuous light diffuser 470 is the same as described with respect to the continuous light diffuser 350 and the discontinuous light diffuser 370 in the third exemplary embodiment 310 of the present invention. With the continuous light diffuser 450 in the position shown in dashed outline in FIG. 6D, the first side edge 456a of the continuous light diffuser 450 is engaged on the first angled flange 441a of the ceiling light fixture housing 430, and the continuous light diffuser 450 is bent and moved upwardly, as indicated by arrow “G”, to allow the second side edge 456b to engage on the second angled flange 441b.

Similarly, the discontinuous light diffuser 470 is moved upwardly to be in partial contact with the continuous light diffuser 450, as indicated by arrow “H” in FIG. 6C to a position as also shown in FIG. 6C and as shown in dashed outline in FIG. 6D, whereat the first side edge 476a of the discontinuous light diffuser 470 is engaged on the first angled flange 441a of the ceiling light fixture housing 430, under the continuous light diffuser 450 (see FIG. 6F which shows an enlarged view of the area of the first side edge 476a in place when the discontinuous light diffuser 470 is fully installed). Next, the discontinuous light diffuser 470 is bent and moved upwardly, as indicated by arrow “I” in FIG. 6C and by arrow “J” in FIG. 6D, to allow the second side edge 476b to engage on the second angled flange 441b, of the ceiling light fixture housing 430, under the continuous light diffuser 450.

The supplemental light diffuser 490 is installed similarly in the following manner. With the continuous light diffuser 450 and the discontinuous light diffuser 470 installed in place, the supplemental light diffuser 490 is moved upwardly to be in partial contact with the discontinuous light diffuser 470, as indicated by arrow “K” in FIG. 6C to a position as also shown in FIG. 6C and as shown in dashed outline in FIG. 6D, whereat the first side edge 496a of the discontinuous light diffuser 490 is engaged on the first angled flange 441a of the ceiling light fixture housing 430, under the discontinuous light diffuser 470 (see FIG. 6F which shows an enlarged view of the area of the first side edge 496a in place when the supplemental light diffuser 490 is fully installed). The supplemental light diffuser 490 is then moved upwardly, as indicated by arrow “K” in FIG. 6D, from the position shown in dashed outline to the position shown in solid outline.

The supplemental light diffuser 490 precludes the discontinuous light diffuser 470 from bowing downwardly after it is installed, which is particularly problematic where thin film plastic sheet material is used to form the discontinuous light diffuser 470. Optionally, the supplemental light diffuser 490 may be retained in place by a suitable adhesive (not specifically shown). Also, the supplemental light diffuser 490 may be used to retain in place a narrower discontinuous light diffuser 470 that is not wide enough to extend between and be retained by the first angled flange 441a and the second angled flange 441b.

Other variations are within the spirit of the present invention. Thus, while the invention is susceptible to various modifications and alternative constructions without departing from the spirit of the inventions disclosed and claimed, only a limited number of embodiments or variations thereof have been illustrated or otherwise disclosed herein by way of non-limiting example. It should be understood, however, that there is no intention to limit the invention to the specific form or forms disclosed, but on the contrary, the intention is to cover all modifications, alternative constructions, and equivalents falling within the spirit and scope of the invention, as defined in the appended claims broadly construed.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of any and all examples, or exemplary language (e.g., “such as”, or, “for example”) provided herein, is intended merely to better illuminate embodiments of the invention and does not pose a limitation on the scope of the invention unless otherwise claimed. No language in the specification should be construed as indicating any non-claimed element as essential to the practice of the invention.

Currently preferred embodiments of this invention are described herein. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

I claim:

1. In combination:
a ceiling light fixture housing defining a light emitting opening and a first housing axis and a second housing axis transverse one to the other;
a continuous light diffuser having a main body portion defined between a first surface and a second surface of said continuous light diffuser, said continuous light diffuser positioned within the ceiling light fixture housing to fully cover said light emitting opening formed in the ceiling light fixture housing;
a discontinuous light diffuser having a main body portion defined between a first surface and a second surface of said discontinuous light diffuser, said main body portion having a major axis and a minor axis transverse one to the other; and,
a plurality of openings passing from said first surface of said discontinuous light diffuser through said main body portion to said second surface of said discontinuous light diffuser;
wherein said discontinuous light diffuser is positioned with its body portion in adjacent relation to either one of said first surface and said second surface of the continuous light diffuser so as to occlude a portion of said light emitting opening.

2. The combination according to claim 1, wherein the main body portion of said continuous light diffuser is generally planar.

3. The combination according to claim 2, wherein said first surface of said main body portion of said discontinuous light diffuser is generally planar.

4. The combination according to claim 3, wherein said second surface of said main body portion of said discontinuous light diffuser is generally planar.

5. The combination according to claim 4, wherein said first surface and said second surface of said main body portion of said discontinuous light diffuser are substantially parallel one to the other.

6. The combination according to claim 5, wherein the portion of said light emitting opening occluded by said discontinuous light diffuser is partial.

7. The combination according to claim 1, wherein said plurality of openings in said discontinuous light diffuser forms a pattern.

8. The combination according to claim 7, wherein said plurality of openings in said discontinuous light diffuser forms a regular pattern.

9. The combination according to claim 8, wherein said plurality of openings in said discontinuous light diffuser forms an array.

10. The combination according to claim 9, wherein said plurality of openings in said discontinuous light diffuser forms a regular array of circular openings.

11. The combination according to claim 10, wherein said regular array of circular openings comprises alternating rows of circular openings having a first size and circular openings having a second size.

12. The combination according to claim 1, wherein said plurality of openings in said discontinuous light diffuser forms at least one of symbols and letters and numbers.

13. The combination according to claim 12, wherein said symbols and letters and numbers form a commercial message.

14. The combination according to claim 1, wherein said plurality of openings in said discontinuous light diffuser forms a decorative pattern.

15. The combination according to claim 1, wherein said plurality of openings in said discontinuous light diffuser forms seasonal shapes or figures.

16. The combination according to claim 1, wherein the first housing axis of the ceiling light fixture housing and the major axis of the discontinuous light diffuser are parallel one to the other and the second housing axis of the ceiling light fixture housing and the minor axis of the discontinuous light diffuser are parallel one to the other.

17. The combination according to claim 16, wherein said ceiling light fixture housing is longer along said first axis and shorter along said second axis and said discontinuous light diffuser is longer along said major axis and shorter along said minor axis.

18. The combination according to claim 17, wherein the shape of the discontinuous light diffuser is rectangular.

19. The combination according to claim 1, wherein the discontinuous light diffuser is positioned with its second surface in contacting relation with the first surface of the continuous light diffuser.

20. The combination according to claim 1, wherein the discontinuous light diffuser is positioned with its first surface in contacting relation with the second surface of the continuous light diffuser.

21. The combination according to claim 20, further comprising supplemental means for attaching the discontinuous light diffuser in contacting relation with the continuous light diffuser.

22. The combination according to claim 21, wherein the supplemental means for attaching the discontinuous light diffuser in contacting relation with the continuous light diffuser comprises a supplemental light diffuser.

23. The combination according to claim 22, wherein the supplemental light diffuser is optically clear.

24. The combination according to claim 1, wherein the main body portion of each of the continuous light diffuser and the discontinuous light diffuser is curved.

25. The combination according to claim 1, wherein the main body portion of each of the continuous light diffuser and the discontinuous light diffuser is curved to the same shape one as the other.
